(19) United States
(12) Patent Application Publication
(10) Pub. No.: US 2014/0339474 A1
(43) Pub. Date: Nov. 20, 2014

(54) SILICONE COMPOSITION COMPRISING NANOPARTICLES AND CURED PRODUCT FORMED THEREFROM

(71) Applicant: DOW CORNING CORPORATION, MIDLAND, MI (US)

(72) Inventors: James A. Casey, Merrill, MI (US); Steven Swier, Midland, MI (US); David Witker, Bay City, MI (US)

(21) Appl. No.: 14/278,502

(22) Filed: May 15, 2014

Related U.S. Application Data
(60) Provisional application No. 61/823,500, filed on May 15, 2013.

(51) Int. Cl. C09K 11/59

(52) U.S. Cl. CPC C09K 11/59
USPC 252/301.36

(57) ABSTRACT

A silicone composition comprises a curable silicone composition and nanoparticles. The nanoparticles of the silicone composition are produced via a plasma process. A cured product formed from the silicone composition is also disclosed. The cured product includes the nanoparticles dispersed therein.

### CROSS-REFERENCE TO RELATED APPLICATIONS

This application claims the benefit of U.S. Provisional Application Ser. No. 61/823,500, filed on May 15, 2013, the disclosure of which is hereby incorporated by reference in its entirety.

### FIELD OF THE INVENTION

The present invention generally relates to silicone compositions and, more specifically, to a silicone composition comprising nanoparticles and to a cured product formed from the silicone composition.

### DESCRIPTION OF THE RELATED ART

Nanoparticles are known in the art and can be prepared via various processes. For example, nanoparticles are often defined as particles having at least one dimension of less than 100 nanometers and are produced either from a bulk material, which is initially larger than a nanoparticle, or from particles smaller than the nanoparticles, such as ions and/or atoms. Nanoparticles are particularly unique in that they may have significantly different properties than the bulk material or the smaller particles from which the nanoparticles are derived. For example, a bulk material that acts as an insulator or semiconductor can be, when in nanoparticle form, electrically conductive.

One method of producing nanoparticles starting with the bulk material is attrition. In this method, the bulk material is disposed in a mill, thereby reducing the bulk material to nanoparticles and other larger particles. The nanoparticles can be separated from the other larger particles via air classification.

Nanoparticles have also been produced by laser ablation utilizing a pulsed laser. In laser ablation, bulk metals are placed in aqueous and/or organic solvents and the bulk metals are exposed to the pulsed laser (e.g. copper vapor or neodymium-doped yttrium aluminum garnet). The nanoparticles are ablated from the bulk metal by laser irradiation and subsequently form a suspension in the aqueous and/or organic solvents. However, the pulsed laser is expensive and, additionally, the nanoparticles produced from laser ablation are typically limited to metal nanoparticles.

### SUMMARY OF THE INVENTION AND ADVANTAGES

The present invention provides a silicone composition. The silicone composition comprises a curable silicone composition and nanoparticles. The nanoparticles of the silicone composition are produced via a plasma process.

The present invention also provides a cured product formed from the silicone composition. The cured product includes the nanoparticles dispersed therein.

The silicone composition of the present invention may be utilized to form cured products having characteristic physical properties that make the cured products suitable in numerous and diverse end uses and applications.

### BRIEF DESCRIPTION OF THE DRAWINGS

Other advantages and aspects of this invention may be described in the following detailed description when considered in connection with the accompanying drawings wherein:

FIG. 1 illustrates one embodiment of a low pressure high frequency pulsed plasma reactor for producing nanoparticles;

FIG. 2 illustrates another embodiment of a low pressure high frequency pulsed plasma reactor for producing nanoparticles;

FIG. 3 illustrates an embodiment of a system including a low pressure pulsed plasma reactor to produce nanoparticles and a diffusion pump to collect the nanoparticles; and

FIG. 4 illustrates a schematic view of one embodiment of a diffusion pump for collecting nanoparticles produced via a reactor.

### DETAILED DESCRIPTION OF THE INVENTION

The present invention provides a silicone composition. The silicone composition comprises a curable silicone composition and nanoparticles produced via a plasma process. The silicone composition of the instant invention may be utilized to produce cured products having excellent physical properties and which are suitable for use in numerous different applications and end uses.

The curable silicone composition is not particularly limited and may be curable through numerous different functionalities or reaction mechanisms. The terminology “curable silicone composition” refers to silicone compositions that can be cured, i.e., cross-linked, to form a cured product having a solid form. To the end, the cured product formed from the curable silicone composition may comprise any combination of siloxane units, i.e., the cured product may comprise any combination of R₃SiO_{1/2} units, i.e., M units, R₂SiO_{2/2} units, i.e., D units, RSiO_{3/2} units, i.e., T units, and SiO_{4/2} units, i.e., Q units, where R is typically a substituted or unsubstituted hydrocarbyl group. For example, the cured product may comprise a rubber, a gel, a resin, or combinations thereof, i.e., the cured product may be continuous or discontinuous in terms of its composition. For example, when the cured product comprises a rubber or a gel, the curable silicone composition utilized to form the cured product generally comprises at least one polymer including repeating D units, i.e., a linear or partly branched polymer. Alternatively, when the cured product is resinous, the curable silicone composition utilized to form the cured product generally includes a silicone resin having T and/or Q units.

In various embodiments, the curable silicone composition comprises a silicone resin such that the cured product formed from the curable silicone composition is resinous. In these embodiments, the silicone resin may comprise a DT resin, an MT resin, an MDT resin, a DTQ resin, an MTQ resin, an MDTQ resin, a DQ resin, an MQ resin, a DTQ resin, an MTQ resin, or an MDQ resin.

Independent of the type of cured product, in certain embodiments, the curable silicone is selected from a hydrosilylation-curable silicone composition, a radiation-curable silicone composition, a peroxide-curable silicone composition, and a condensation-curable silicone composition.

When the curable silicone composition comprises the hydrosilylation-curable silicone composition, the curable silicone composition generally comprises: (i) an organopolysiloxane having an average of at least two silicon-bonded alkenyl groups per molecule; (ii) an organosilicon compound having an average of at least two silicon-bonded hydrogen atoms per molecule; and (iii) a hydrosilylation catalyst.

The organopolysiloxane may be linear, branched, partly branched, or resinous. Typically, the organopolysiloxane is resinous, i.e., the organopolysiloxane comprises T and/or Q units. The organosilicon compound and may be further defined as an organohydrogensilane, an organohydrogensiloxane, or a combination thereof. The structure of the organosilicon compound can be linear, branched, cyclic, or resinous. In acyclic polysilanes and polysiloxanes, the silicon-bonded hydrogen atoms can be located at terminal, pendant, or at both terminal and pendant positions. The hydrosilylation catalyst can be any known hydrosilylation catalyst. For example, the hydrosilylation catalyst typically includes a platinum group metal, a compound containing a platinum group metal, or a microencapsulated platinum group metal-containing catalyst. Platinum group metals include, but are not limited to, platinum, rhodium, ruthenium, palladium, osmium, and iridium. The hydrosilylation catalyst generally comprises platinum based on its high activity in hydrosilylation reactions. The hydrosilylation-curable silicone composition may further comprise additional reactive or non-reactive organopolysiloxanes, one or more solvents, diluents, fillers, etc.

When the curable silicone composition comprises the radiation-curable silicone composition, the radiation-curable silicone composition may be curable by, for example, UV radiation or high energy radiation, such as γ-rays and electron beams. To this end, when the radiation-curable silicone composition is curable by UV radiation, the radiation-curable silicone composition typically comprises: (i) an organopolysiloxane containing radiation-sensitive functional groups; and (ii) a photoinitiator. The organopolysiloxane may be linear, branched, partly branched, or resinous. Typically, the organopolysiloxane is resinous, i.e., the organopolysiloxane comprises T and/or Q units. Examples of radiation-sensitive functional groups include, but are not limited to, acryloyl, methacryloyl, mercapto, epoxy, and alkenyl ether groups. The radiation-sensitive functional groups may be located at any suitable molecular position, including, but not limited to, terminal, pendant, or both terminal and pendant positions. The type of photoinitiator utilized typically depends on the nature of the radiation-sensitive groups in the organopolysiloxane. Examples of photoinitiators include, but are not limited to, diaryliodonium salts, sulfonium salts, acetophenone, benzophenone, and benzoin and its derivatives. The radiation-curable silicone composition may further comprise additional reactive or non-reactive organopolysiloxanes, one or more solvents, diluents, fillers, etc.

When the curable silicone composition comprises the peroxide-curable silicone composition, the curable silicone composition generally comprises: (i) an organopolysiloxane; and (ii) an organic peroxide. The organopolysiloxane may be linear, branched, partly branched, or resinous. Typically, the organopolysiloxane is resinous, i.e., the organopolysiloxane comprises T and/or Q units. Examples of organic peroxides include, but are not limited to, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aroyl peroxides such as t-butyl perbenzoate, t-butyl peracetate, and t-butyl peroctoate.

When the curable silicone composition comprises the condensation-curable silicone composition, the condensation-curable silicone composition generally comprises (i) an organopolysiloxane; and (ii) optionally a condensation catalyst. The organopolysiloxane may be linear, branched, partly branched, or resinous. Typically, the organopolysiloxane is resinous, i.e., the organopolysiloxane comprises T and/or Q units. Typically, the organopolysiloxane includes silanol groups, or optionally silicon-bonded hydrolysable groups that may undergo hydrolysis to form silanol groups in the presence of water. Examples of condensation catalysts include, but are not limited to, amines; and complexes of lead, tin, zinc, titanium, zirconium, bismuth, and iron with carboxylic acids. Tin(II) octoates, laureates, and oleates, as well as the salts of dibutyl tin, are particularly useful.

In various embodiments of the present invention, the curable silicone composition comprises the condensation-curable silicone composition. In one specific embodiment, the condensation-curable silicone composition comprises (A) an organosiloxane block copolymer, which may also be described as a “resin-linear” organosiloxane block copolymer.

The organosiloxane block copolymer typically has a weight average molecular weight (M_{w}) of at least 20,000 g/mole. In various embodiments, the organosiloxane block copolymer has a weight average molecular weight of at least 40,000, 50,000, 60,000, 70,000, or 80,000, g/mole. Alternatively, the organosiloxane block copolymer may have a weight average molecular weight of from 40,000 to 100,000, from 50,000 to 90,000, from 60,000 to 80,000, from 60,000 to 70,000, from 100,000 to 500,000, from 150,000 to 450,000, from 200,000 to 400,000, from 250,000 to 350,000, from 250,000 to 300,000, g/mol. In still other embodiments, the organosiloxane block copolymer has a weight average molecular weight of from 40,000 to 60,000, from 45,000 to 55,000, or about 50,000, g/mol. The weight average molecular weight may be determined via Gel Permeation Chromatography (GPC) techniques using polystyrene (PS) standards.

“Linear” organopolysiloxanes typically include mostly D or (R₂SiO_{2/2}) siloxy units, which results in polydiorganosiloxanes that are fluids of varying viscosity, depending on the “degree of polymerization” or DP as indicated by the number of D units in the polydiorganosiloxane. “Linear” organopolysiloxanes typically have glass transition temperatures (T_{g}) that are lower than 25° C.

“Resin” organopolysiloxanes include a weight or molar majority of T or Q siloxy units. When T siloxy units are predominately used to prepare an organopolysiloxane, the resulting organosiloxane is often described as a “silsesquioxane resin”. Increasing the amounts of T or Q siloxy units in an organopolysiloxane typically results in organopolysiloxane copolymers having increasing hardness and/or glass like properties. “Resin” organopolysiloxanes typically have higher T_{g} values than linear organopolysiloxanes. For example, organopolysiloxane resins often have T_{g} values greater than 50° C.

As described above, the organosiloxane block copolymer may also be described as a “resin-linear” organosiloxane block copolymer. The terminology “resin-linear” typically describes organosiloxane block copolymer including “linear” D siloxy units in combination with “resin” T siloxy units. The present organosiloxane copolymers are “block” copolymers, as opposed to “random” copolymers. As such, the present organosiloxane block copolymer describes an organopolysiloxane including D and T siloxy units, where the D units are primarily bonded together to form polymeric chains having 10 to 400 D units, which are described herein as “linear blocks”. The T units are primarily bonded to each other to form branched polymeric chains, which are described as “non-linear blocks”. One or more non-linear blocks may further aggregate to form “nano-domains” in the organosiloxane block copolymer.

The organosiloxane block copolymer of this disclosure includes:

(A) 40 to 90 mole percent disiloxy units of the formula [R¹₂SiO_{2/2}] arranged in linear blocks each having an average of from 10 to 400 disiloxy units [R¹₂SiO_{2/2}] per linear block; and
(B) 10 to 60 mole percent trisiloxy units of the formula [R²SiO_{3/2}] arranged in non-linear blocks each having a molecular weight of at least 500 g/mol.
In certain embodiments, the organosiloxane block copolymer further comprises:
(C) 0.5 to 25 mole percent silanol groups [≡SiOH].

In addition, in certain embodiments, at least 30% of the non-linear blocks are crosslinked with another non-linear block and aggregated in nano-domains. Alternatively, alternatively at least at 40% of the non-linear blocks are crosslinked with another non-linear block, and alternatively at least at 50% of the non-linear blocks are crosslinked with another non-linear block. Furthermore, each linear block is linked to at least one non-linear block.

The aforementioned formulas may be alternatively described as [R¹₂SiO_{2/2}]ₐ[R²SiO_{3/2}]_{b} where the subscripts a and b represent the mole fractions of the siloxy units in the organosiloxane block copolymer. In these formulas, a may vary from 0.4 to 0.9, from 0.5 to 0.9, or from 0.6 to 0.9. Also in these formulas, b can vary from 0.1 to 0.6, from 0.1 to 0.5 or from 0.1 to 0.4. Moreover, in these formulas, R¹ may be independently a C₁ to C₃₀ hydrocarbyl. The hydrocarbyl may independently be an alkyl, aryl, or alkylaryl group. As used herein, hydrocarbyl also includes halogen substituted hydrocarbyls. Alternatively, R¹ may be a C₁ to C₁₈ or a C₁ to C₆, alkyl group such as methyl, ethyl, propyl, butyl, pentyl, or hexyl group. Alternatively R¹ may be methyl. R¹ may be an aryl group, such as phenyl, naphthyl, or an anthryl group. Alternatively, R¹ may be any combination of the aforementioned alkyl or aryl groups. Alternatively, R¹ is phenyl, methyl, or a combination of both.

Relative to R², each R² may independently be a C₁ to C₂₀ hydrocarbyl. As used herein, hydrocarbyl also includes halogen substituted hydrocarbyls. R² may alternatively be an aryl group, such as a phenyl, naphthyl, or anthryl group. Alternatively, R² may be an alkyl group, such as methyl, ethyl, propyl, or butyl. Alternatively, R² may be any combination of the aforementioned alkyl or aryl groups. Alternatively, R² is phenyl or methyl.

The organosiloxane block copolymer may include additional siloxy units, such as M siloxy units, Q siloxy units, other unique D or T siloxy units (e.g. having a organic groups other than R¹ or R²), so long as the organosiloxane block copolymer includes the mole fractions of the disiloxy and trisiloxy units as described above. In other words, the sum of the mole fractions as designated by subscripts a and b, do not necessarily have to sum to one. The sum of a+b may be less than one to account for amounts of other siloxy units that may be present in the organosiloxane block copolymer. For example, the sum of a+b may be greater than 0.6, greater than 0.7, greater than 0.8, greater than 0.9, greater than 0.95, or greater than 0.98 or 0.99.

In one embodiment, the organosiloxane block copolymer consists essentially of the disiloxy units of the formula [R¹₂SiO_{2/2}] and trisiloxy units of the formula [R²SiO_{3/2}], in the aforementioned weight percentages, while also including 0.5 to 25 mole percent silanol groups [≡SiOH], wherein R¹ and R² are as described above. Thus, in this embodiment, the sum of a+b (when using mole fractions to represent the amount of disiloxy and trisiloxy units in the copolymer) is greater than 0.95, alternatively greater than 0.98. Moreover, in this embodiment, the terminology “consisting essentially of” describes that the organosiloxane block copolymer is free of other siloxane units not described immediately above.

In one embodiment, the organosiloxane block copolymer includes at least 30, at least 50, at least 60, or at least 70, weight percent of disiloxy units. The amount of disiloxy and trisiloxy units in the organosiloxane block copolymer may be described according to the weight percent of each in the organosiloxane block copolymer. In one embodiment, the disiloxy units have the formula [(CH₃)₂SiO_{2/2}]. In a further embodiment, the disiloxy units have the formula [(CH₃)(C₆H₅)SiO_{2/2}].

The formula [R¹₂SiO_{2/2}]ₐ[R²SiO_{3/2}]_{b}, and related formulae using mole fractions, as described herein, do not limit the structural ordering of the disiloxy [R¹₂SiO_{2/2}] and trisiloxy [R²SiO_{3/2}] units in the organosiloxane block copolymer. Rather, these formulae provide a non-limiting notation to describe the relative amounts of the two units in the organosiloxane block copolymer, as per the mole fractions described above via the subscripts a and b. The mole fractions of the various siloxy units in the organosiloxane block copolymer, as well as the silanol content, may be determined by ²⁹Si NMR techniques.

Referring back to the silanol groups (SiOH), the amount of silanol groups present in the organosiloxane block copolymer typically varies from 0.5 to 35 mole percent silanol groups [≡SiOH], alternatively from 2 to 32 mole percent silanol groups [≡SiOH], and alternatively from 8 to 22 mole percent silanol groups [≡SiOH]. The silanol groups may be present in any siloxy units within the organosiloxane block copolymer. The amounts described above represent the total amount of silanol groups in the organosiloxane block copolymer. In one embodiment, a molar majority of the silanol groups are bonded to trisiloxy units, i.e., the resin component of the block copolymer.

The silanol groups present on the resin component of the organosiloxane block copolymer may allow the organosiloxane block copolymer to further react or cure at elevated temperatures or to cross-link. The crosslinking of the non-linear blocks may be accomplished via a variety of chemical mechanisms and/or moieties. For example, crosslinking of non-linear blocks within the organosiloxane block copolymer may result from the condensation of residual silanol groups present in the non-linear blocks of the organosiloxane block copolymer.

Crosslinking of the non-linear blocks within the organosiloxane block copolymer may also occur between “free resin” components and the non-linear blocks. “Free resin” components may be present in the organosiloxane block copolymer as a result of using an excess amount of an organosiloxane resin during the preparation of the organosiloxane block copolymer. The free resin components may crosslink with the non-linear blocks by condensation of the residual silanol groups present in the non-blocks and in the free resin components. The free resin components may alternatively provide crosslinking by reacting with lower molecular weight compounds such as those utilized as crosslinkers, as described in greater detail below.

Alternatively, certain compounds can be added during preparation of the organosiloxane block copolymer to crosslink non-resin blocks. These crosslinking compounds may include an organosilane having the formula R⁵_{q}SiX_{4-q} which may be utilized during the formation of the organosiloxane block copolymer (see, for example, step II of the method as described below). In the aforementioned formula, R⁵ is typically a C₁ to C₈ hydrocarbyl or a C₁ to C₈ halogen-substituted hydrocarbyl, X is typically a hydrolysable group, and q is typically 0, 1, or 2. R⁵ may alternatively be a C₁ to C₈ halogen-substituted hydrocarbyl, a C₁ to C₈ alkyl group, a phenyl group, or a methyl group, an ethyl group, a combination of methyl and ethyl groups, or a combination of phenyl/methyl or phenyl/ethyl groups. X may be any hydrolyzable group, such as an oximo, acetoxy, halogen atom, hydroxyl (OH), or an alkoxy group. In one embodiment, the organosilane is an alkyltriacetoxysilane, such as methyltriacetoxysilane, ethyltriacetoxysilane, or a combination of both. Commercially available representative alkyltriacetoxysilanes include ETS-900 (Dow Corning Corp., Midland, Mich.). Other suitable, non-limiting organosilanes useful as crosslinkers include methyl-tris(methylethylketoxime)silane (MTO), methyl triacetoxysilane, ethyl triacetoxysilane, tetraacetoxysilane, tetraoximesilane, dimethyl diacetoxysilane, dimethyl dioximesilane, methyl tris(methylmethylketoxime)silane. Typically, crosslinks within the organosiloxane block copolymer are siloxane bonds ≡Si—O—Si≡, resulting from the condensation of silanol groups.

The amount of crosslinking in the organosiloxane block copolymer may be estimated by determining an average molecular weight of the organosiloxane block copolymer, such as with GPC techniques. Typically, crosslinking the organosiloxane block copolymer increases average molecular weight. Thus, an estimation of the extent of crosslinking may be made, given the average molecular weight of the organosiloxane block copolymer, the selection of the linear siloxy component (i.e., chain length as indicated by degree of polymerization), and the molecular weight of the non-linear block (which may be primarily controlled by the selection of the organosiloxane resin used to prepare the organosiloxane block copolymer).

The organosiloxane block copolymer may be isolated in a solid form, for example by casting films of a solution of the organosiloxane block copolymer in an organic solvent and allowing the solvent to evaporate. Upon drying or forming a solid, the non-linear blocks of the organosiloxane block copolymer typically aggregate together to form “nano-domains”. As used herein, “predominately aggregated” describes that a majority of non-linear blocks of the organosiloxane block copolymer are typically found in certain regions of the organosiloxane block copolymer, described herein as the “nano-domains”. As used herein, “nano-domains” describes phase regions within the organosiloxane block copolymer that are phase separated and possess at least one dimension, e.g. length, width, depth, or height, sized from 1 to 100 nanometers. The nano-domains may vary in shape, providing at least one dimension of the nano-domain is sized from 1 to 100 nanometers. Thus, the nano-domains may be regular or irregularly shaped. The nano-domains may be spherically shaped, tubular shaped, and in some instances lamellar shaped.

The organosiloxane block copolymer may include a first phase and an incompatible second phase, the first phase including predominately the disiloxy units [R¹₂SiO_{2/2}] and the second phase including predominately the trisiloxy units [R²SiO_{3/2}], wherein the non-linear blocks are aggregated into nano-domains which are incompatible with the first phase.

The structural ordering of the disiloxy and trisiloxy units, and characterization of the nano-domains, may be determined using analytical techniques such as Transmission Electron Microscopic (TEM) techniques, Atomic Force Microscopy (AFM), Small Angle Neutron Scattering, Small Angle X-Ray Scattering, and Scanning Electron Microscopy.

Alternatively, the structural ordering of the disiloxy and trisiloxy units in the block copolymer, and formation of nano-domains, may be inferred by determining certain physical properties of the organosiloxane block copolymer, e.g. when the organosiloxane block copolymer is used as a coating. In one embodiment, a coating formed from the organosiloxane block copolymer and/or organosiloxane block copolymer has an optical transmittance of visible light greater than 95%. Such optical clarity is typically only possible when visible light is able to pass through a medium and not be diffracted by particles (or domains as used herein) having a size greater than 150 nanometers. As the particle size (domains) decreases, optical clarity may increase.

The organosiloxane block copolymer of this disclosure may include phase separated “soft” and “hard” segments resulting from blocks of linear D units and aggregates of blocks of non-linear T units, respectively. These respective soft and hard segments may be determined or inferred by differing glass transition temperatures (T_{g}). Thus a linear segment may be described as a “soft” segment typically having a low T_{g}, for example less than 25° C., alternatively less than 0° C., or alternatively even less than −20° C. The linear segments typically maintain “fluid” like behavior in a variety of conditions. Conversely, non-linear blocks may be described as “hard segments” having higher T_{g}, values, for example greater than 30° C., alternatively greater than 40° C., or alternatively even greater than 50° C.

In various embodiments, the organosiloxane block copolymer can be processed several times if a processing temperature (T_{processing}) is less than a temperature required to cure (T_{cure}), i.e., if T_{processing}<T_{cure}. In various embodiments, the organosiloxane block copolymer will cure and achieve high temperature stability when T_{processing}>T_{cure}. Thus, the organopolysiloxane block copolymer may offer the advantage of being “re-processable” in conjunction with the benefits typically associated with silicones, such as hydrophobicity, high temperature stability, and moisture/UV resistance.

In one embodiment, the solid composition may be described as a “melt” or as “melt processable.” In this embodiment, the solid composition may exhibit fluid behavior at elevated temperatures, e.g. upon “melting”. The melt flow temperature may be determined by measuring the storage modulus (G′), loss modulus (G″) and tan delta as a function of temperature storage using commercially available instruments. For example, a commercial rheometer (such as TA Instruments' ARES-RDA—with 2KSTD standard flexular pivot spring transducer, with forced convection oven) may be used to measure the storage modulus (G′), loss modulus (G″) and tan delta as a function of temperature. Test specimens (typically 8 mm wide, 1 mm thick) may be loaded in between parallel plates and measured using small strain oscillatory rheology while ramping the temperature in a range from 25° C. to 300° C. at 2° C./min (frequency 1 Hz). The flow onset may be calculated as the inflection temperature in the G′ drop (e.g. flow), the viscosity at 120° C. is reported as a measure for melt processability and the cure onset is calculated as the onset temperature in the G′ rise (e.g. cure). Typically, the FLOW of the solid composition will also correlate to the glass transition temperature of the non-linear segments (i.e. the resin component) in the organosiloxane block copolymer. Alternatively, the “melt processability” and/or cure of the solid composition may be determined by rheological measurements at various temperatures. In a further embodiment, the solid composition may have a melt flow temperature of from 25 to 200, from 25 to 160, or from 50 to 160, ° C.

In one embodiment, the solid composition is “curable”. In this embodiment, the solid composition may undergo further physical property changes through curing the organosiloxane block copolymer. As described above, the organosiloxane block copolymer includes a certain amount of silanol groups. The presence of these silanol groups may allow for further reactivity, i.e. a cure mechanism. Upon curing, the physical properties of solid composition may be further altered.

The structural ordering of the disiloxy and trisiloxy units in the organosiloxane block copolymer as described above may provide the organosiloxane block copolymer with certain unique physical property characteristics when the solid composition are formed. For example, the structural ordering of the disiloxy and trisiloxy units in the copolymer may provide solid composition that allow for a high optical transmittance of visible light. The structural ordering may also allow the organosiloxane block copolymer to flow and cure upon heating, yet remain stable at room temperature. The siloxy units may also be processed using lamination techniques. These properties may be useful to provide coatings for various electronic articles to improve weather resistance and durability, while providing low cost and easy procedures that are energy efficient.

In the embodiment described above in which the condensation-curable silicone composition comprises the organopolysiloxane block copolymer, the condensation-curable silicone composition may further comprise an organic solvent. The organic solvent typically is an aromatic solvent, such as benzene, toluene, or xylene. Alternatively to an organic solvent, a silicone fluid or diluent may be utilized.

The condensation-curable silicone composition may further include an organosiloxane resin in addition to, and independently from, the organosiloxane block copolymer. The organosiloxane resin that may be utilized in the condensation-curable silicone composition typically is the same organosiloxane resin used to prepare the organosiloxane block copolymer. Thus, the organosiloxane resin in the curable silicone composition may comprise at least 60 mol of [R²SiO_{3/2}] siloxy units in its formula, where each R² is independently a C₁ to C₂₀ hydrocarbyl. Alternatively, the organosiloxane resin may be a silsesquioxane resin, or alternatively a phenyl silsesquioxane resin.

The amount of the organosiloxane block copolymer, organic solvent, and optional organosiloxane resin in the condensation-curable silicone composition may vary. In various embodiments, the condensation-curable silicone composition includes 40 to 80 weight % of the organosiloxane block copolymer as described above, 10 to 80 weight % of the organic solvent, and 5 to 40 weight % of the organosiloxane resin, providing the sum of the weight % of these components does not exceed 100%. In one embodiment, the curable silicone composition consists essentially of the organosiloxane block copolymer as described above, the organic solvent, and the organosiloxane resin. In this embodiment, the weight % of these components sum to 100%, or nearly 100%. The terminology “consisting essentially of” relative to the immediately aforementioned embodiment, describes that, in this embodiment, the curable silicone composition is free of silicone or organic polymers that are not the organosiloxane block copolymer or organosiloxane resin of this disclosure. The weight percentages described above relate solely to the condensation-curable silicone composition and do not include the weight of the nanoparticles of the silicone composition.

The condensation-curable silicone composition may also include a cure catalyst. The cure catalyst may be chosen from any catalyst known in the art to affect (condensation) cure of organosiloxanes, such as various tin or titanium catalysts. Condensation catalysts can be any condensation catalyst typically used to promote condensation of silicon bonded hydroxy (silanol) groups to form Si—O—Si linkages. Examples include, but are not limited to, amines, complexes of lead, tin, titanium, zinc, and iron.

In one embodiment, a linear soft block siloxane unit, e.g. with dp>2, is grafted to a linear or resinous “hard block” siloxane unit with a glass transition above room temperature. In a related embodiment, the organosiloxane block copolymer (e.g. silanol ended) is reacted with a silane such as methyl triacetoxy silane and/or methyl trioxime silane, followed by reaction with a silanol functional phenyl silsesquioxane resin. In still other embodiments, the organosiloxane block copolymer includes one or more soft blocks (e.g. block with glass transition<25° C.) and one or more linear siloxane “pre-polymer” blocks possibly including aryl groups as side chains, e.g. in poly(phenyl methyl siloxane). In another embodiment, the organosiloxane block copolymer includes PhMe-D contents>20 mol % and PhMe-D dp>2 and/or Ph2-D/Me2-D (mol/mol 3/7)>20 mol %. In still other embodiments, the organosiloxane block copolymer includes one or more hard blocks (e.g. blocks with glass transition>25° C.) and one or more linear or resinous siloxanes, for example, phenyl silsesquioxane resins, which may be used to form non-tacky films. Typically, the organosiloxane block copolymer has a refractive index of greater than 1.4.

Additional aspects of this particular embodiment of the condensation-curable silicone composition, including aspects of the organosiloxane block copolymer, and methods of its preparation, can be found in U.S. Appln. Ser. No. 61/581,852, which was filed on Dec. 30, 2011 and is incorporated by reference herein in its entirety.

The condensation-curable silicone composition may be formed using a method that includes the step of combining the organosiloxane block copolymer and the organic solvent, as described above. The method may also include one or more steps of introducing and/or combining additional components, such as the organosiloxane resin and/or cure catalyst to one or both of the organosiloxane block copolymer and the solvent. The organosiloxane block copolymer and the solvent may be combined with each other and/or any other components using any method known in the art such as stirring, vortexing, mixing, etc.

Regardless of the type of curable silicone composition utilized in the silicone composition, the silicone composition further comprises nanoparticles, as introduced above. The nanoparticles of the silicone composition are produced via a plasma process. As readily understood in the art, the process by which nanoparticles are produced generally impacts the physical properties and characteristics of the resulting nanoparticles.

In various embodiments, the nanoparticles of the curable silicone composition are produced via an RF plasma-based process. In these embodiments, a constricted RF plasma may be utilized to produce the nanoparticles. More specifically, these processes utilize an RF plasma operated in a constricted mode to produce nanoparticles from a precursor gas.

In these embodiments, the process of producing the nanoparticles may be carried out by introducing a precursor gas and, optionally, a buffer gas into a plasma chamber and generating an RF capacitive plasma in the chamber. The RF plasma may be created under pressure and RF power conditions that promote the formation of a plasma instability (i.e., a spatially and temporally strongly non-uniform plasma) which causes a constricted plasma to form in the chamber. The constricted plasma, sometimes also referred to as contracted plasma, leads to the formation of a high-plasma density filament, sometimes also referred to as a plasma channel. The plasma channel is characterized by a strongly enhanced plasma density, ionization rate, and gas temperature as compared to the surrounding plasma. It can be either stationary or non-stationary. Periodic rotations of the filament in the discharge tube may be observed, e.g. the filament may randomly change its direction of rotation, trajectory and frequency of rotation. The filament may appear longitudinally non-uniform, or striated. In other cases, the filament may be longitudinally uniform.

An inert buffer or carrier gas, such as neon, argon, krypton or xenon, may desirably be included with the precursor gas. The inclusion of such gases in the constricted plasma-based methods is particularly desirable because these gases promote the formation of the thermal instability to achieve the thermal constriction. In the RF plasmas, dissociated precursor gas species (i.e., the dissociation products resulting from the dissociation of the precursor molecules) nucleate and grow into nanoparticles.

It is believed that the formation of a constricted RF plasma promotes crystalline nanoparticle formation because the constricted plasma results in the formation of a high current density current channel (i.e., filament) in which the local degree of ionization, plasma density and gas temperature are much higher than those of ordinary diffuse plasmas which tend to produce amorphous nanoparticles. For example, in some instances gas temperatures of at least about 1000 K with plasma densities of up to about 10¹³ cm⁻³ may be achieved in the constricted plasma. Additional effects could lead to further heating of the nanoparticles to temperatures even higher than the gas temperature. These include recombination of plasma electrons and ions at the nanoparticle surface, hydrogen recombination at the particle surface and the condensation heat release related to nanoparticle surface growth. In some instances the nanoparticles may be heated to temperatures several hundred degrees Kelvin above the gas temperature. The plasma may be continuous, rather than a pulsed plasma.

Thus, some embodiments of the present processes use an RF plasma constriction to provide high gas temperatures using relatively low plasma frequencies.

Conditions that promote the formation of a constricted plasma may be achieved by using sufficiently high RF powers and gas pressures when generating the RF plasma. Any RF power and gas pressures that result in the formation of a constricted RF plasma capable of promoting nanoparticle formation from dissociated precursor gas species may be employed. Appropriate RF power and gas pressure levels may vary somewhat depending upon the plasma reactor geometry. However, in one illustrative embodiment of the processes provided herein, the RF power used to ignite the RF plasma is at least about 100 Watts and the total pressure in the plasma chamber in the presence of the plasma (i.e., the total plasma pressure) is at least about 1 Torr. This includes embodiments where the RF power is at least about 110 Watts and further includes embodiments where the RF power is at least about 120 Watts. This also includes embodiments where the total pressure in the plasma chamber in the presence of the plasma is at least about 5 Torr and further includes embodiments where the total pressure in the plasma chamber in the presence of the plasma is at least about 10 Torr (e.g. from about 10 to 15 Torr).

Conditions that promote the formation of a non-constricted RF plasmas may be similar to those described above for the production of constricted plasmas. However, nanoparticles are generally formed in the non-constricted plasmas at lower pressures, higher precursor gas flow rates, and lower buffer gas flow rates. For example, in some embodiments, the nanoparticles are produced in an RF plasma at a total pressure less than about 5 Torr and, desirably, less than about 3 Torr. This includes embodiments where the total pressure in the plasma reactor in the presence of the plasma is about 1 to 3 Torr. Typical flow rates for the precursor gas in these embodiments may be at least 5 sccm, including embodiments where the flow rate for the precursor gas is at least about 10 sccm. Typical flow rates for buffer gases in these embodiments may be about 1 to 50 sccm.

The frequency of the RF voltage used to ignite the radiofrequency plasmas may vary within the RF range. In certain embodiments, a frequency of 13.56 MHz is employed, which is the major frequency used in the RF plasma processing industry. However, the frequency may desirably be lower than the microwave frequency range, i.e., lower than about 1 GHz. This includes embodiments where the frequency will desirably be lower than the very high frequency (VHF) range (e.g. lower than about 30 MHz). For example, the present methods may generate radiofrequency plasmas using radio frequencies of 25 MHz or less.

Additional aspects relating to this particular embodiment in which the nanoparticles are produced via this plasma process are described in U.S. Pat. No. 7,446,335 and U.S. Pat. No. 8,016,944, which are each incorporated by reference herein in their respective entireties.

In other embodiments, the nanoparticles of the silicone composition are prepared in a low pressure plasma reactor, such as a low pressure high frequency pulsed plasma reactor.

In these embodiments, pulsing the plasma enables an operator to directly set the resident time for particle nucleation and thereby control the particle size distribution and agglomeration kinetics in the plasma. For example, the operating parameters of the pulsed reactor may be adjusted to form crystalline nanoparticles or amorphous nanoparticles. Semiconductor containing precursors enter into the dielectric discharge tube where the capacitively coupled plasma, or inductively coupled plasma, is operated. Nanoparticles start to nucleate as the precursor molecules are dissociated in the plasma. When the plasma is off, or in a low ion energy state, during the pulsing cycle, the charged nanoparticles can be evacuated to the reactor chamber where they may be deposited on a substrate or subjected to further processing.

The power may be supplied via a variable frequency radio frequency power amplifier that is triggered by an arbitrary function generator to establish the high frequency pulsed plasma. In one embodiment, the radiofrequency power is capacitively coupled into the plasma using a ring electrode, parallel plates, or an anode/cathode setup in the gas. Alternatively, the radiofrequency power may be inductively coupled mode into the plasma using an RF coil setup around the discharge tube. The precursor gases can be controlled via mass flow controllers or calibrated rotometers. The pressure differential from the discharge tube to the reactor chamber can be controlled through a changeable grounded or biased orifice. Depending on the orifice size and pressures, the nanoparticle distributions into the reactor chamber may change, thus providing another process parameter that can be used to adjust the properties of the resulting nanoparticles.

In one embodiment, the plasma reactor may be operated in the frequency from 10 MHz to 500 MHz at pressures from 100 mTorr to 10 Torr in the discharge tube and powers from 5 watts to 1000 watts.

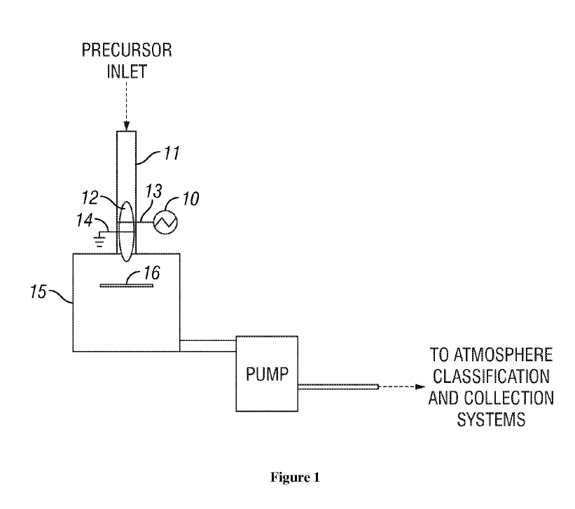

Referring now to FIG. 1, one exemplary embodiment of a low pressure high frequency pulsed plasma reactor is shown. In the illustrated embodiment, precursor gas (or gases) may be introduced to a vacuum evacuated dielectric discharge tube 11. The discharge tube 11 includes an electrode configuration 13 that is attached to a variable frequency RF amplifier 10. The other portion of the electrode 14 is either grounded, DC biased, or operated in a push-pull manner relative to electrode 13. The electrodes 13, 14 are used to couple the very high frequency (VHF) power into the precursor gas (or gases) to ignite and sustain a glow discharge or plasma 12. The precursor gas (or gases) may then be disassociated in the plasma and nucleate to form nanoparticles.

In one embodiment, the electrodes 13, 14 for a plasma source inside the dielectric tube 11 that is a flow-through showerhead design in which a VHF radio frequency biased upstream porous electrode plate 13 is separated from a down stream porous electrode plate 14, with the pores of the plates aligned with one another. The pores could be circular, rectangular, or any other desirable shape. Alternatively, the dielectric tube 11 may enclose an electrode 13 that is coupled to the VHF radio frequency power source 10 and has a pointed tip that has a variable distance between the tip and a grounded ring 14 inside the dielectric tube 11. In this case, the VHF radio frequency power source 10 operates in a frequency range of about 10 to 500 MHz. In another alternative embodiment, the pointed tip 13 can be positioned at a variable distance between the tip and a VHF radio frequency powered ring 14 operated in a push-pull mode (180° out of phase). In yet another alternative embodiment, the electrodes 13, 14 include an inductive coil coupled to the VHF radio frequency power source so that radio frequency power is delivered to the precursor gas (or gases) by an electric field formed by the inductive coil. Portions of the dielectric tube 11 can be evacuated to a vacuum level between 1×10⁻⁷ to 500 Torr.

The nucleated nanoparticles may pass into a larger vacuum evacuated reactor 15, where collection on a solid substrate 16 (including a chuck) or into an appropriate liquid substrate/solution can occur. For example, the nanoparticles may be collected in the curable silicone composition to form the silicone composition of the invention. Alternatively, the nanoparticles may be collected in a capture fluid and subsequently introduced to the curable silicone composition to form the silicone composition. The solid substrate 16 can be electrically grounded, biased, temperature controlled, rotating, positioned relative the electrodes producing the nanoparticles, or on a roll-to-roll system. If deposition onto substrates is not the choice, then the particles are evacuated into a suitable pump for transition to atmospheric pressure. The nanoparticles can then be sent to an atmospheric classification system, such as a differential mobility analyzer, and collected for further functionalization or other processing. In the illustrated embodiment, the plasma is initiated with a high frequency plasma via an RF power amplifier such as an AR Worldwide Model KAA2040 or an Electronics and Innovation 3200L. The amplifier can be driven (or pulsed) by an arbitrary function generator (e.g., a Tektronix AFG3252 function generator) that is capable of producing up to 200 watts of power from 0.15 to 150 MHz. In various embodiments, the arbitrary function may be able to drive the power amplifier with pulse trains, amplitude modulation, frequency modulation, or different waveforms. The power coupling between the amplifier and the precursor gas typically increases as the frequency of the RF power increases. The ability to drive the power at a higher frequency may therefore allow more efficient coupling between the power supply and discharge.

If desired, nanoparticles having varying agglomeration lengths can be produced by nucleating the nanoparticles from at least one precursor gas in a VHF radio frequency low pressure plasma discharge and collecting the nucleated nanoparticles by controlling the mean free path of the nanoparticles as an aerosol, thus allowing particle-particle interactions prior to collection. The nucleated nanoparticles may be collected on a solid substrate within a vacuum environment where the collection distance is greater than the mean free path of the particles controlled via the pressure. The agglomeration lengths of the nanoparticles can thereby be controlled. Alternatively, the nucleated nanoparticles may be collected in a liquid substrate within a vacuum environment where the collection distance is greater than the mean free path of the particles controlled via the pressure thus controlling the agglomeration lengths of the nanoparticles. The further away the substrate is from the nucleation region (plasma discharge), the longer the agglomerations are at a constant pressure. The synthesized nanoparticles may be evacuated out of the low pressure environment into an atmospheric environment as an aerosol so that the agglomeration length is at least partially controlled by the concentration of the aerosol.

In certain embodiments, nanoparticles can be produced by synthesizing crystalline or amorphous core nanoparticles using VHF radio frequency low pressure plasma that is discharged in a low pressure environment by pulsing the discharge to control the plasma residence time. For example, the amorphous core nanoparticles can be synthesized at increased plasma residence time relative to the precursor gas molecular residence time through a VHF radio frequency low pressure plasma discharge. Alternatively, crystalline core nanoparticles can be synthesized at lower plasma residence times at the same operating conditions of discharge drive frequency, drive amplitude, discharge tube pressure, chamber pressure, plasma power density, gas molecule residence time through the plasma, and collection distance from plasma source electrodes.

Additional aspects relating to this particular embodiment in which the nanoparticles are produced via this plasma process are described in International (PCT) Publication No. WO 2010/027959 (PCT/US2009/055587), which is incorporate by reference herein in its entirety.

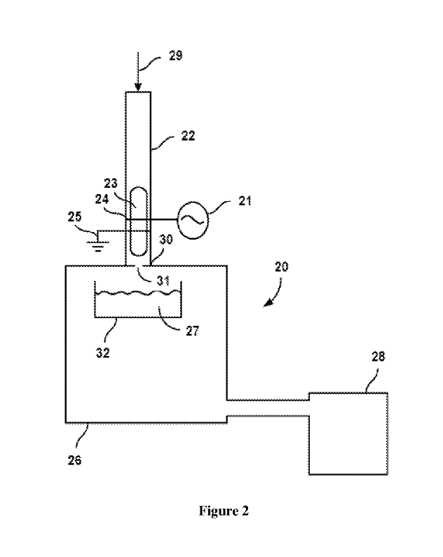

Referring to FIG. 2, an alternative embodiment of a plasma reactor system is shown at 20. In this embodiment, the plasma reactor system 20 comprises a plasma generating chamber 22 having a reactant gas inlet 29 and an outlet 30 having an aperture or orifice 31 therein. A particle collection chamber 26 is in communication with the plasma generating chamber 22. The particle collection chamber 26 contains a capture fluid 27 in a container 32. The container 32 may be adapted to be agitated (by means not shown). For example, the container 32 may be positioned on a rotatable support (not shown) or may include a stifling mechanism. Preferably the capture fluid is a liquid at the temperatures of operation of the system. The plasma reactor system 5 also includes a vacuum source 28 in communication with the particle collection chamber 26 and plasma generating chamber 22.

The plasma generating chamber 22 comprises an electrode configuration 24 that is attached to a variable frequency RF amplifier 21. The plasma generating chamber 22 also comprises a second electrode configuration 25. The second electrode configuration 25 is either ground, DC biased, or operated in a push-pull manner relative to the electrode configuration 24. The electrodes 24, 25 are used to couple the very high frequency (VHF) power to the reactant gas mixture to ignite and sustain a glow discharge of plasma within the area identified as 23. The first reactive precursor gas (or gases) is then dissociated in the plasma to provide charged atoms which nucleate to form nanoparticles. However, other discharge tube configurations are contemplated, and may be used in carrying out the method disclosed herein.

In the embodiment of FIG. 2, the nanoparticles are collected in the particle collection chamber 26 in the capture fluid. To control the diameter of the nanoparticles which are formed, the distance between the aperture 31 in the outlet 22 of plasma generating chamber 22 and the surface of the capture fluid ranges between about 5 to about 50 aperture diameters. It has been found that positioning the surface of the capture fluid too close to the outlet of the plasma generating chamber may result in undesirable interactions of plasma with the capture fluid. Conversely, positioning the surface of the capture fluid too far from the aperture reduces particle collection efficiency. As collection distance is a function of the aperture diameter of the outlet and the pressure drop between the plasma generating chamber and the collection chamber, based on the operating condition described herein, an acceptable collection distance is from about 1 to about 20, alternatively from about 5 to about 10, cm. Said differently, an acceptable collection distance is from about 5 to about 50 aperture diameters.

The plasma generating chamber 22 also comprises a power supply. The power is supplied via a variable frequency radio frequency power amplifier 21 that is triggered by an arbitrary function generator to establish high frequency pulsed plasma in area 23. Preferably, the radiofrequency power is capacitively coupled into the plasma using a ring electrode, parallel plates, or an anode/cathode setup in the gas. Alternatively, the radiofrequency power may be inductively coupled mode into the plasma using an RF coil setup around the discharge tube.

The plasma generating chamber 11 may also comprise a dielectric discharge tube. Preferably, a reactant gas mixture enters the dielectric discharge tube where the plasma is generated. Nanoparticles which form from the reactant gas mixture start to nucleate as the first reactive precursor gas molecules are dissociated in the plasma.

The vacuum source 28 may comprise a vacuum pump. Alternatively, the vacuum source 28 may comprise a mechanical, turbo molecular, or cryogenic pump.

In one embodiment, the electrodes 24, 25 for a plasma source inside the plasma generating chamber 22 comprise a flow-through showerhead design in which a VHF radio frequency biased upstream porous electrode plate 24 is separated from a down stream porous electrode plate 25, with the pores of the plates aligned with one another. The pores may be circular, rectangular, or any other desirable shape. Alternatively, the plasma generating chamber 22 may enclose an electrode 24 that is coupled to the VHF radio frequency power source and has a pointed tip that has a variable distance between the tip and a grounded ring inside the chamber 22.

In one embodiment, the VHF radio frequency power source may be operated in a manner substantially similar to that described above with respect to the embodiment of FIG. 1. The plasma in area 23 may be initiated with a high frequency plasma via an RF power amplifier such as an AR Worldwide Model KAA2040, or an Electronics and Innovation Model 3200L, or an EM Power RF Systems, Inc. Model BBS2E3KUT. The amplifier can be driven (or pulsed) by an arbitrary function generator, as described above relative to the embodiment of FIG. 1.

In one embodiment, the power and frequency of the plasma system is preselected to create an optimal operating space for the formation of the nanoparticles. Preferably, tuning both the power and frequency creates an appropriate ion and electron energy distribution in the discharge to help dissociate the molecules of the reactive precursor gas and nucleate the nanoparticles.

The plasma reactor system 20 illustrated in FIG. 2 may be pulsed to enable an operator to directly manage the resident time for particle nucleation, and thereby control the particle size distribution and agglomeration kinetics in the plasma. The pulsing function of the system 20 allows for controlled tuning of the particle resident time in the plasma, which affects the size of the nanoparticles. By decreasing the “on” time of the plasma, the nucleating particles have less time to agglomerate, and therefore the size of the nanoparticles may be reduced on average (i.e., the nanoparticle distribution may be shifted to smaller diameter particle sizes).

Advantageously, the operation of the plasma reactor system 20 at higher frequency ranges and pulsing the plasma provides the same conditions as in conventional constricted/filament discharge techniques that use a plasma instability to produce the high ion energies/densities, but with the additional advantage that users can control operating conditions to select and produce nanoparticles having various sizes, which impacts their characteristic physical properties, e.g. photoluminescence.

For a pulse injection, the synthesis of the nanoparticles can be done with a pulsed energy source, such as a pulsed very high frequency RF plasma, a high frequency RF plasma, or a pulsed laser for pyrolysis. Preferably, the VHF radiofrequency is pulsed at a frequency ranging from about 1 to about 50 kHz.

Another method to transfer the nanoparticles to the capture fluid is to pulse the input of the reactant gas mixture while the plasma is ignited. For example, one could ignite the plasma in which a first reactive precursor gas is present to synthesize the nanoparticles, with at least one other gas present to sustain the discharge, such as an inert gas. The nanoparticle synthesis is stopped when the flow of first reactive precursor gas is stopped with a mass flow controller. The synthesis of the nanoparticles continues when the flow of the first reactive precursor gas is started again. This produces a pulsed stream of nanoparticles. This technique can be used to increase the concentration of nanoparticles in the capture fluid if the flux of nanoparticles impinging on the capture fluid is greater than the absorption rate of the nanoparticles into the capture fluid.

In another embodiment, the nucleated nanoparticles are transferred from the plasma generating chamber 22 to particle collection chamber 26 containing capture fluid via the aperture or orifice 31 which creates a pressure differential. It is contemplated that the pressure differential between the plasma generating chamber 22 and the particle collection chamber 26 can be controlled through a variety of ways. In one configuration, the discharge tube inside diameter of the plasma generating chamber 22 is much less than the inside diameter of the particle collection chamber 26, thus creating a pressure drop. In another configuration, a grounded physical aperture or orifice may be placed between the discharge tube and the collection chamber 26 that forces the plasma to reside partially inside the orifice, based on the Debye length of the plasma and the size of the chamber 22. Another configuration comprises using a varying electrostatic orifice in which a positive concentric charge is developed that forces the negatively charged plasma through the aperture 31.

It is contemplated that the capture fluid may be used as a material handling and storage medium. In one embodiment, the capture fluid is selected to allow nanoparticles to be absorbed and disperse into the fluid as they are collected, thus forming a dispersion or suspension of nanoparticles in the capture fluid. Nanoparticles will be adsorbed into the fluid if they are miscible with the fluid. For example, the nanoparticles may be collected in the curable silicone composition to form the silicone composition of the invention. Alternatively, the nanoparticles may be collected in a capture fluid and subsequently introduced to the curable silicone composition to form the silicone composition.

The capture fluid is selected to have the desired properties for nanoparticle capture and storage. In a specific embodiment, the vapor pressure of the capture fluid is lower than the operating pressure in the plasma reactor. Preferably, the operating pressure in the reactor and collection chamber 26 range from about 1 to about 5 mTorr. Other operating pressures are also contemplated. The capture fluid may comprise a silicone fluid such as polydimethylsiloxane, phenylmethyl-dimethyl cyclosiloxane, tetramethyltetraphenyltrisiloxane, and/or pentaphenyltrimethyltrisiloxane.

The capture fluid may be agitated during the direct capture of the nanoparticles, e.g. by stirring, rotation, inversion, and other suitable methods of providing agitation. If higher absorption rates of the nanoparticles into the capture liquid are desired, more intense forms of agitation are contemplated, e.g. ultrasonication.

As first introduced above, in the embodiment of FIG. 2, upon the dissociation of the first reactive precursor gas in the plasma generation chamber 22, nanoparticles form and are entrained in the gas phase. The distance between the nanoparticle synthesis location and the surface of capture fluid must be short enough so that no unwanted functionalization occurs while the nanoparticles are entrained. If the nanoparticles interact within the gas phase, agglomerations of numerous individual small nanoparticles will form and be captured in the capture fluid. If too much interaction takes place within the gas phase, the nanoparticles may sinter together and form nanoparticles having larger average diameters. The collection distance is defined as the distance from the outlet of the plasma generating chamber to the surface of the capture fluid.

Additional aspects relating to this particular embodiment in which the nanoparticles are produced via this plasma process are described in International (PCT) Publication No. WO 2011/109299 (PCT/US2011/026491), which is incorporated by reference herein in its entirety.

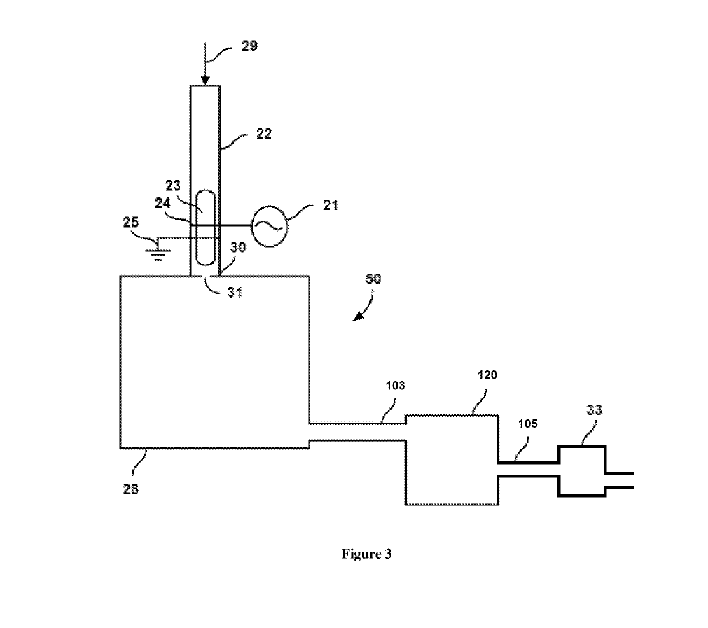

Referring to FIG. 3, an alternative embodiment of a plasma reactor system is shown at 50. In this embodiment, the nanoparticles of the silicone composition are prepared in a system having a reactor for producing a nanoparticle aerosol (e.g., nanoparticles in a gas) and a diffusion pump in fluid communication with the reactor for collecting the nanoparticles of the aerosol. For example, nanoparticles of various size distributions and properties can be prepared by introducing a nanoparticle aerosol produced in a reactor (e.g. a low-pressure plasma reactor) into a diffusion pump in fluid communication with the reactor, capturing the nanoparticles of the aerosol in a condensate from a diffusion pump oil, liquid, or fluid (e.g. silicone fluid), and collecting the captured nanoparticles in a reservoir.

Example reactors are described in WO 2010/027959 and WO 2011/109229, each of which is described above and incorporated by reference in its entirety herein. Such reactors can be, but are not limited to, low pressure high frequency pulsed plasma reactors. For example, FIG. 3 illustrates the plasma reactor of the embodiment of FIG. 2, but includes the diffusion pump in fluid communication with the reactor. To this end, description relative to this particular plasma reactor is not repeated herein with respect to the embodiment of FIG. 3.

In the embodiment of FIG. 3, the plasma reactor system 50 includes a diffusion pump 120. As such, the nanoparticles can be collected by the diffusion pump 120. A particle collection chamber 26 may be in fluid communication with the plasma generating chamber 22. The diffusion pump 120 may be in fluid communication with the particle collection chamber 26 and the plasma generating chamber 22. In other forms of the present disclosure, the system 50 may not include the particle collection chamber 26. For example, the outlet 30 may be coupled to an inlet 103 of the diffusion pump 120, or the diffusion pump 120 may be in substantially direct fluid communication with the plasma generating chamber 22.

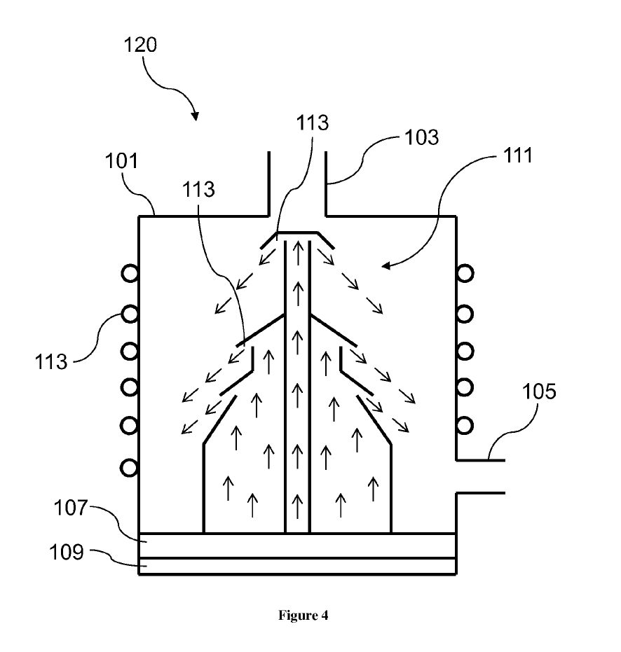

FIG. 4 is a cross-sectional schematic of an example diffusion pump 120 suitable for the system 50 of the embodiment of FIG. 3. The diffusion pump 120 can include a chamber 101 having an inlet 103 and an outlet 105. The inlet 103 may have a diameter of about 2 to about 55 inches, and the outlet may have a diameter of about 0.5 to about 8 inches. The inlet 103 of the chamber 101 is in fluid communication with the outlet 30 of the reactor 20. The diffusion pump 120 may have, for example, a pumping speed of about 65 to about 65,000 liters/second or greater than about 65,000 liters/second.

The diffusion pump 120 includes a reservoir 107 in fluid communication with the chamber 101. The reservoir 107 supports or contains a diffusion pump fluid. The reservoir may have a volume of about 30 cc to about 15 liters. The volume of diffusion pump fluid in the diffusion pump may be about 30 cc to about 15 liters.

The diffusion pump 120 can further include a heater 109 for vaporizing the diffusion pump fluid in the reservoir 107 to a vapor. The heater 109 heats up the diffusion pump fluid and vaporizes the diffusion pump fluid to form a vapor (e.g., liquid to gas phase transformation). For example, the diffusion pump fluid may be heated to about 100 to about 400° C. or about 180 to about 250° C.

A jet assembly 111 can be in fluid communication with the reservoir 107 comprising a nozzle 113 for discharging the vaporized diffusion pump fluid into the chamber 101. The vaporized diffusion pump fluid flows and rises up though the jet assembly 111 and emitted out the nozzles 113. The flow of the vaporized diffusion pump fluid is illustrated in FIG. 4 with arrows. The vaporized diffusion pump fluid condenses and flows back to the reservoir 107. For example, the nozzle 113 can discharge the vaporized diffusion pump fluid against a wall of the chamber 101. The walls of the chamber 101 may be cooled with a cooling system 113 such as a water cooled system. The cooled walls of the chamber 101 can cause the vaporized diffusion pump fluid to condense. The condensed diffusion pump fluid can then flow along and down the walls of the chamber 101 and back to the reservoir 107. The diffusion pump fluid can be continuously cycled through diffusion pump 120. The flow of the diffusion pump fluid causes gas that enters the inlet 103 to diffuse from the inlet 103 to the outlet 105 of the chamber 101. A vacuum source 33 may be in fluid communication with the outlet 105 of the chamber 101 to assist removal of the gas from the outlet 105.

As the gas flows through the chamber 101, nanoparticles in the gas can be absorbed by the diffusion pump fluid, thereby collecting the nanoparticles from the gas. For example, a surface of the nanoparticles may be wetted by the vaporized and/or condensed diffusion pump fluid. Furthermore, the agitating of cycled diffusion pump fluid may further improve absorption rate of the nanoparticles compared to a static fluid. The pressure within the chamber 101 may be less than about 1 mTorr.

The diffusion pump fluid with the nanoparticles can then be removed from the diffusion pump 120. For example, the diffusion pump fluid with the nanoparticles may be continuously removed and replaced with diffusion pump fluid that substantially does not have nanoparticles.

Advantageously, the diffusion pump 120 can be used not only for collecting nanoparticles but also evacuating the reactor 20 (and collection chamber 26). For example, the operating pressure in the reactor 20 can be a low pressure, e.g. less than atmospheric pressure, less than 760 Torr, or between about 1 and about 760 Torr. The collection chamber 26 can, for example, range from about 1 to about 5 mTorr. Other operating pressures are also contemplated.

The diffusion pump fluid can be selected to have the desired properties for nanoparticle capture and storage. The diffusion pump fluid may be the same as the capture fluid described above relative to the embodiment of FIG. 2. Similarly, the diffusion pump fluid may comprise the curable silicone composition, or a component of the curable silicone composition, such that the silicone composition of the invention is formed once the nanoparticles are captured in the diffusion pump fluid. Alternatively, the nanoparticles may be separated or isolated from the diffusion pump fluid and combined with the curable silicone composition. For example, the diffusion pump fluid may be centrifuged and/or decanted to concentrate or isolate the nanoparticles therein. Other diffusion pump fluids and oils may include hydrocarbons, phenyl ethers, fluorinated polyphenyl ethers, and ionic fluids. The fluid may have a viscosity of from 0.001 to 1.0, from 0.005 to 0.50, or from 0.01 to 0.10, Pa·s at 23±3° C. Furthermore, the fluid may have a vapor pressure of less than about 1×10⁻⁴ Torr.

The system 50 may also include a vacuum pump or vacuum source 33 in fluid communication with the outlet 105 of the diffusion pump 120. The vacuum source 33 can be selected in order for the diffusion pump 120 to operate properly. In one form of the present disclosure, the vacuum source 33 comprises a vacuum pump (e.g., auxiliary pump). The vacuum source 33 may comprise a mechanical, turbo molecular, or cryogenic pump. However, other vacuum sources are also contemplated.

One method of producing nanoparticles with the system 50 of FIG. 3 can include forming a nanoparticle aerosol in the reactor 20. The nanoparticle aerosol can comprise nanoparticles in a gas, and the method further includes introducing the nanoparticle aerosol into the diffusion pump 120 from the reactor 5. The method also may include heating the diffusion pump fluid in a reservoir 107 to form a vapor, sending the vapor through a jet assembly 111, emitting the vapor through a nozzle 113 into a chamber 101 of the diffusion pump 120, condensing the vapor to form a condensate, and flowing the condensate back to the reservoir 107. Furthermore, the method can further include capturing the nanoparticles of the aerosol in the condensate and collecting the captured nanoparticles in the reservoir 107. The method can further include removing the gas from the diffusion pump with a vacuum pump.

Additional aspects relating to this particular embodiment in which the nanoparticles are produced via this plasma process are described in U.S. Appln. Ser. No. 61/655,635, which is incorporate by reference herein in its entirety.

Regardless of the particular plasma system and process utilized to produce the nanoparticles of the silicone composition, the plasma system generally relies on a precursor gas, as introduced above in the various embodiments. The precursor gas may alternatively be referred to as a reactant gas mixture or a gas mixture. The precursor gas is generally selected based on a desired composition of the nanoparticles, as described in greater detail below with reference to the nanoparticles. For example, when the nanoparticles comprise silicon nanoparticles, the precursor gas may contain silicon, and when the nanoparticles comprise germanium, the precursor gas may contain germanium. Furthermore, the precursor gas may be selected from silanes, disilanes, halogen-substituted silanes, halogen-substituted disilanes, C₁-C₄ alkyl silanes, C₁-C₄ alkyldisilanes, and mixtures thereof. In one form of the present disclosure, precursor gas may comprise silane which comprises from about 0.1 to about 2% of the total gas mixture. However, the gas mixture may also comprise other percentages of silane and/or additional or alternative precursor gasses, as described below with reference to the nanoparticles formed therefrom.

The precursor gas may be mixed with other gases such as inert gases to form a gas mixture. Examples of inert gases that may be included in the gas mixture include argon, xenon, neon, or a mixture of inert gases. When present in the gas mixture, the inert gas may comprise from about 1% to about 99% of the total volume of the gas mixture. The precursor gas may have from about 0.1% to about 50% of the total volume of the gas mixture. However, it is also contemplated that the precursor gas may comprise other volume percentages such as from about 1% to about 50% of the total volume of the gas mixture.

In one form of the present disclosure, the reactant gas mixture also comprises a second precursor gas which itself can comprise from about 0.1 to about 49.9 volume % of the reactant gas mixture. The second precursor gas may comprise BCl₃, B₂H₆, PH₃, GeH₄, or GeCl₄. The second precursor gas may also comprise other gases that contain carbon, germanium, boron, phosphorous, or nitrogen. The combination of the first precursor gas and the second precursor gas together may make up from about 0.1 to about 50% of the total volume of the reactant gas mixture.

In another form of the present disclosure, the reactant gas mixture further comprises hydrogen gas. Hydrogen gas can be present in an amount of from about 1% to about 10% of the total volume of the reactant gas mixture. However, it is also contemplated that the reactant gas mixture may comprise other percentages of hydrogen gas.

Nanoparticles for the silicone composition can be prepared by any of the methods described above. Contingent on the precursor gas and molecules utilized in the plasma process, nanoparticles of various composition may be produced. For example, the nanoparticles may be semiconducting nanoparticles comprising at least one element selected from Group IV, Group IV-IV, Group II-IV, and Group III-V. Alternatively, the nanoparticles may be metal nanoparticles comprising at least one element selected from Group IIA, Group IIIA, Group IVA, Group VA, Group IB, Group IIB, Group IVB, Group VB, Group VIB, Group VIIB, and Group VIIIB metals. These Group designations of the periodic table are generally from the CAS or old IUPAC nomenclature, although Group IV elements are referred to as group 14 elements under the modern IUPAC system, as readily understood in the art. Alternatively still, the nanoparticles may be metal alloy nanoparticles, metal oxide nanoparticles, metal nitride nanoparticles, ceramic nanoparticles, etc.

The processes provided herein are particularly well-suited for use in the production of nanoparticles that are single-crystal and comprise Group IV semiconductors, including silicon, germanium and tin, from precursor molecules containing these elements. Silane and germane are examples of precursor molecules that may be used in the production of nanoparticles comprising silicon and germanium, respectively. Organometallic precursor molecules may also be used. These molecules include a Group IV metal and organic groups. Organometallic Group IV precursors include, but are not limited to organosilicon, organogermanium and organotin compounds. Some examples of Group IV precursors include, but are not limited to, alkylgermaniums, alkylsilanes, alkylstannanes, chlorosilanes, chlorogermaniums, chlorostannanes, aromatic silanes, aromatic germaniums and aromatic stannanes. Other examples of silicon precursors include, but are not limited to, disilane (Si₂H₆), silicon tetrachloride (SiCl₄), trichlorosilane (HSiCl₃) and dichlorosilane (H₂SiCl₂). Still other suitable precursor molecules for use in forming crystalline silicon nanoparticles include alkyl and aromatic silanes, such as dimethylsilane (H₃C—SiH₂—CH₃), tetraethyl silane ((CH₃CH₂)₄Si) and diphenylsilane (Ph-SiH₂-Ph). In addition to germane, particular examples of germanium precursor molecules that may be used to form crystalline Ge nanoparticles include, but are not limited to, germanium tetrachloride (GeCl₄), tetraethyl germane ((CH₃CH₂)₄Ge) and diphenylgermane (Ph-GeH₂-Ph).

In certain embodiments, the nanoparticles comprise at least one of silicon and germanium. Further, the nanoparticles may comprise silicon alloys and/or germanium alloys. Silicon alloys that may be formed include, but are not limited to, silicon carbide, silicon germanium, silicon boron, silicon phosphorous, and silicon nitride. The silicon alloys may be formed by mixing at least one first precursor gas with the second precursor gas or using a precursor gas that contains the different elements. However, other methods of forming alloyed nanoparticles are also contemplated.

In another form of the present disclosure, the nanoparticles may undergo an additional doping step. For example, the nanoparticles may undergo gas phase doping in the plasma, where a second precursor gas is dissociated and is incorporated in the nanoparticles as they are nucleated. The nanoparticles may also undergo doping in the gas phase downstream of the production of the nanoparticles, but before the nanoparticles are captured in the liquid. Furthermore, doped nanoparticles may also be produced in the diffusion pump fluid where the dopant is preloaded into the diffusion pump fluid and interacts with the nanoparticles after they are captured. Doped nanoparticles can be formed by contact with organosilicon gases or liquids, including, but not limited to trimethylsilane, disilane, and trisilane. Gas phase dopants may include, but are not limited to, BCl₃, B₂H₆, PH₃, GeH₄, or GeCl₄.

The nanoparticles may exhibit a number of unique electronic, magnetic, catalytic, physical, optoelectronic and optical properties due to quantum confinement effects. For example, many semiconductor nanoparticles exhibit photoluminescence effects that are significantly greater than the photoluminescence effects of macroscopic materials having the same composition.

The nanoparticles may have a largest dimension or average largest dimension less than 50, less than 20, less than 10, or less than 5, nm. Furthermore, the largest dimension or average largest dimension of the nanoparticles may be between 1 and 50, between 2 and 50, between 2 and 20, between 2 and 10, or between about 2.2 and about 4.7, nm. The nanoparticles can be measured by a variety of methods, such as with a transmission electron microscope (TEM). For example, as understood in the art, particle size distributions are often calculated via TEM image analysis of hundreds of different nanoparticles. In various embodiments, the nanoparticles may comprise quantum dots, typically silicon quantum dots. Quantum dots have excitons confined in all three spatial dimensions and may comprise individual crystals, i.e., each quantum dot is a single crystal.

In various embodiments, the nanoparticles may be photoluminescent when excited by exposure to UV light. Depending on the average diameter of the nanoparticles, they may photoluminescence in any of the wavelengths in the visible spectrum and may visually appear to be red, orange, green, blue, violet, or any other color in the visible spectrum. For example, nanoparticles with an average diameter less than about 5 nm may produce visible photoluminescence, and nanoparticles with an average diameter less than about 10 nm may produce near infrared (IR) luminescence. In one form of the present disclosure, the photoluminescent silicon nanoparticles have a photoluminescent intensity of at least 1×10⁶ at an excitation wavelength of about 365 nm. The photoluminescent intensity may be measured with a Fluorolog3 spectrofluorometer (commercially available from Horiba of Edison, N.J.) with a 450 W Xe excitation source, excitation monochromator, sample holder, edge band filter (400 nm), emission monochromator, and a silicon detector photomultiplier tube. To measure photoluminescent intensity, the excitation and emission slit width are set to 2 nm and the integration time is set to 0.1 s. In these or other embodiments, the photoluminescent silicon nanoparticles may have a quantum efficiency of at least 4% at an excitation wavelength of about 395 nm as measured on an HR400 spectrophotometer (commercially available from Ocean Optics of Dunedin, Fla.) via a 1000 micron optical fiber coupled to an integrating sphere and the spectrophotometer with an absorption of >10% of the incident photons. Quantum efficiency was calculated by placing a sample into the integrating sphere and exciting the sample via a 395 nm LED driven by an Ocean Optics LED driver. The system was calibrated with a known lamp source to measure absolute irradiance from the integrating sphere. The quantum efficiency was then calculated by the ratio of total photons emitted by the nanoparticles to the total photons absorbed by the nanoparticles. Further, in these or other embodiments, the nanoparticles may have a full width at half maximum emission of from 20 to 250 at an excitation wavelength of 270-500 nm.

Furthermore, both the photoluminescent intensity and luminescent quantum efficiency may continue to increase over time when the nanoparticles (optionally in the curable silicone composition, capture fluid, or diffusion pump fluid) are exposed to air. In another form of the present disclosure, the maximum emission wavelength of the nanoparticles shifts to shorter wavelengths over time when exposed to oxygen. The luminescent quantum efficiency of the directly captured silicon nanoparticle composition may be increased by about 200% to about 2500% upon exposure to oxygen. However, other increases in the luminescent quantum efficiency are also contemplated. The photoluminescent intensity may increase from 400 to 4500% depending on the time exposure to oxygen and the concentration of the nanoparticles in the fluid. However, other increases in the photoluminescent intensity are also contemplated. The wavelength emitted from the direct capture composition also experiences a blue shift of the emission spectrum. In one form of the present disclosure, the maximum emission wavelength shifts about 100 nm, based on about a 1 nm decrease in nanoparticle core size, depending on the time exposed to oxygen. However, other maximum emission wavelength shifts are also contemplated.

The curable silicone composition may be combined with the nanoparticles to prepare the silicone composition in various manners. For example, the nanoparticles may be disposed in the curable silicone composition in a carrier fluid or as a discrete component, optionally in the presence of mixing. Alternatively, the nanoparticles and the curable silicone composition may be combined and mixed via kneading or milling. Alternatively still, the nanoparticles may be produced and combined with various components utilized to form the curable silicone composition. Said differently, the curable silicone composition may be formed in the presence of the nanoparticles (e.g. in situ), which may allow for higher loadings or concentrations of the nanoparticles in the silicone composition. Generally, the silicone composition comprises the nanoparticles in an amount of from 0.0001 to 80, alternatively from 0.01 to 50, alternatively from 0.1 to 25, percent by weight based on the total weight of the silicone composition. The ranges of the nanoparticles in the silicone composition may vary based on the presence or absence of certain optional components, e.g. solvent (such as toluene).

The present invention also provides a cured product formed from the silicone composition. The cured product is typically formed from curing the silicone composition. Curing of the silicone composition may vary based on the functionality thereof, i.e., the step of curing the silicone composition may vary based on the reaction-mechanism utilized for curing. For example, as introduced above, the silicone composition may be cured by heating, irradiation with active-energy rays, atmospheric moisture, etc. The cured product may have any form, e.g. a film, a slab, etc. and typically contains the nanoparticles dispersed therein. The cured product may be formed on a substrate, such as a release liner, that is optionally separable from the cured product once formed. The cured product generally has excellent physical properties, including luminescence when the nanoparticles dispersed therein are photoluminescent. Further, the cured product may be optically transparent. For example, in certain embodiments, the cured product has a light transmittance of at least 90, at least 95, at least 96, at least 97, at least 98, or at least 99, percent, as determined in accordance with ASTM D1003. The silicone composition utilized to form the cured product and the cured product formed therefrom may have similar or different light transmittance values.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

A curable silicone composition is formed in accordance with the disclosure. In particular, a curable silicone composition is prepared and nanoparticles are produced via a plasma process. The curable silicone composition and the nanoparticles are combined to prepare the silicone composition.

### Preparation Example 1

### Curable Silicone Composition

A 500 mL 3neck round bottom flask is loaded with toluene (65.0 g) and Phenyl-T Resin (27.0 g, 98.0% solids in toluene). The flask is equipped with a thermometer, Teflon stir paddle, and a Dean Stark apparatus prefilled with toluene and attached to a water-cooled condenser. A nitrogen blanket is applied. An oil bath is used to heat the flask at reflux for 30 minutes. Subsequently, the flask is cooled to about 108° C. (pot temperature).

A solution of toluene (22.0 g) and silanol terminated PhMe siloxane (Mw of 25,000 g/mol) (33.0 g) is then prepared and the siloxane is capped with 50/50 MTA/ETA (methyltriacetoxysilane/ethyltriacetoxysilane) (1.04 g; 0.00450 moles Si) in a glove box (same day) under nitrogen by adding 50/50 MTA/ETA to the siloxane and mixing at room temperature for 2 hours. The capped siloxane is then added to the Phenyl-T Resin/toluene solution at 108° C. and refluxed for about 4 hours to form a reaction mixture.

After reflux, the reaction mixture is cooled back to about 108° C. and an additional amount of 50/50 MTA/ETA (4.79 g; 0.0207 moles Si) is added to the reaction mixture and refluxed for an additional 2 hours.

Subsequently, the reaction mixture is cooled to 90° C. and 4.54 g of DI water is added to form a solution. The solution including the water is then heated to reflux for about 1 hour without the removal of the water from the solution. Then, the solution is heated at reflux and water is removed via azeotropic distillation for 20 min at about 109° C. Heating is continued at reflux for about 3 hours.

The solution is cooled to 100° C. and 0.60 g of pre-dried carbon black is added. The mixture is stirred overnight at room temperature and, the following day, the mixture is pressure filtered through a 0.45 μm filter.

### Preparation Example 2

### Nanoparticle Production

Nanoparticles are produced via a plasma process for incorporation into the curable silicone composition. In particular, the nanoparticles are produced via the plasma process exemplified above via the embodiment of FIG. 3 including the diffusion pump.

In particular, 90 sccm Ar, 17 sccm SiH₄ (2% vol. in Ar), and 6 sccm H₂ gas are delivered to the reactor via mass flow controllers. The reactor has a base pressure of less than 2×10⁻⁸ Torr. 14 g of diffusion pump fluid (Dow Corning 705 fluid, commercially available from Dow Corning Corporation of Midland, Mich.) is disposed into the chamber of the reactor at an operating pressure of 1×10⁻⁴ Torr, rotating at 15 rpm.

The reactor operates at 120 W coupled plasma power at 127 MHZ in the discharge tube at 3.5 Torr.

Nanoparticles are synthesized and injected into the diffusion pump fluid located about 5 cm downstream from the orifice. The nanoparticles are produced at a rate of about 0.01 wt % Si nanoparticles per 5 minutes.

The nanoparticles are removed from the reactor via a load lock and nitrogen atmosphere glove box. The nanoparticles are disposed in the diffusion pump fluid, which is centrifuged and decanted to concentrate the nanoparticles.

### Example 1

### Silicone Composition

The concentrated nanoparticles of Preparation Example 2 are ultrasonically mixed and subsequently blended with a 70% solids toluene solution of the curable silicone composition of Preparation Example 1 at 24 wt % of nanoparticles to total solids weight to prepare the silicone composition.

### Example 2

### Cured Product

The silicone composition of Example 1 is disposed as a film on a Teflon release liner via a 5 mil draw down bar. The film is cured for 1 h at 70° C. The resulting cured product has a thickness of about 60 micron and is optically transparent.

### Example 3

### Cured Product

The silicone composition of Example 1 is hot pressed at about 80° C. and a pressure of 0.5 ton to form a sheet having a thickness of about 1 mm. The resulting cured product, i.e., the sheet, is optically transparent and retains luminescence when excited with light having a wavelength of 365 nm.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

What is claimed is:

1. A silicone composition, comprising:
a curable silicone composition; and
nanoparticles produced via a plasma process.

2. The silicone composition according to claim 1 wherein said curable silicone composition is selected from a hydrosilylation-curable silicone composition, a radiation-curable silicone composition, a peroxide-curable silicone composition, and a condensation-curable silicone composition.

3. The silicone composition according to claim 1 wherein said curable silicone composition is a condensation-curable silicone composition.

4. The silicone composition according to claim 3 wherein said condensation-curable silicone composition comprises (A) an organosiloxane block copolymer comprising:
40 to 90 mole percent disiloxy units of the formula [R¹₂SiO_{2/2}] arranged in linear blocks each having an average of from 10 to 400 disiloxy units [R¹₂SiO_{2/2}] per linear block; and
10 to 60 mole percent trisiloxy units of the formula [R²SiO_{3/2}] arranged in non-linear blocks each having a weight average molecular weight of at least 500 g/mol;
wherein each R¹ is independently a C₁ to C₃₀ hydrocarbyl group and each R² is independently a C₁ to C₂₀ hydrocarbyl group; and
wherein each linear block is linked to at least one non-linear block.

5. The silicone composition according to claim 4 wherein said disiloxy units of said organosiloxane block copolymer have the formula [(CH₃)(C₆H₅)SiO_{2/2}].

6. The silicone composition according to claim 4 wherein said organosiloxane block copolymer comprises at least 30 weight percent disiloxy units.

7. The silicone composition according to claim 4 wherein R² is phenyl.

8. The silicone composition according to claim 4 wherein said organopolysiloxane block copolymer is a solid.

9. The silicone composition according to claim 8 wherein said organopolysiloxane block copolymer has a refractive index greater than 1.4.

10. The silicone composition according to claim 4 wherein said organopolysiloxane block copolymer is a melt.

11. The silicone composition according to claim 1 wherein said nanoparticles have an average largest dimension of from 1 to 50 nm.

12. The silicone composition according to claim 1 wherein said nanoparticles comprise at least one of silicon and germanium.

13. The silicone composition according to claim 1 wherein said nanoparticles are photoluminescent.

14. The silicone composition according to claim 13 wherein said nanoparticles comprise quantum dots.

15. The silicone composition according to claim 13 wherein said nanoparticles have an average largest dimension of less than 5 nm.

16. The silicone composition according to claim 13 having a photoluminescent intensity of at least 1×10⁶ at an excitation wavelength of about 365 nm.

17. The silicone composition according to claim 13 having a quantum efficiency of at least 4% at an excitation wavelength of about 365 nm.

18. The silicone composition according to claim 13 having a full width at half maximum emission of from 20 to 250 at an excitation wavelength of 270-500 nm.

19. The silicone composition according to claim 1 further comprising a solvent.

20. The silicone composition according to claim 19 wherein said solvent comprises an aromatic hydrocarbon.

21. A cured product of the silicone composition according to claim 1.

22. The cured product according to claim 21 wherein said nanoparticles are dispersed in said cured product.
